(19) United States
(12) Patent Application Publication
(10) Pub. No.: US 2013/0059734 A1
(43) Pub. Date: Mar. 7, 2013

(54) Epigenetic analysis

(71) Applicants: Peter L. Molloy, Chatswood (AU); Jason P. Ross, Carlingford (AU)

(72) Inventors: Peter L. Molloy, Chatswood (AU); Jason P. Ross, Carlingford (AU)

(73) Assignee: COMMONWEALTH SCIENTIFIC AND INDUSTRIAL RESEARCH ORGANISATION, Canberra (Australian Capital Territory) (AU)

(21) Appl. No.: 13/509,236

(22) PCT Filed: Nov. 15, 2010
(86) PCT No.: PCT/AU10/01525

§ 371 Date: Nov. 21, 2012

(30) Foreign Application Priority Data
Nov. 13, 2009 (AU) 2009905590

(51) Int. Cl. C40B 50/06; C40B 20/00

(52) U.S. Cl. 506/2; 506/26

(57) ABSTRACT

Provided herein are methods for the analysis of methylation in nucleic acid molecules, comprising bisulfite conversion and subsequent copying or amplification in the presence of a ligand-labelled dCTP or a ligand-labelled dGTP incorporated at the site of a cytosine or complementary guanine, respectively, at positions corresponding to methylated cytosines in the bisulfite-treated nucleic acid or after the copying or amplification, subjecting the resulting nucleic acid molecules to restriction endonuclease digestion with an enzyme which comprises a cytosine nucleotide in its target recognition sequence to generate nucleic acid fragments with termini proximal or adjacent to one or more cytosines and attaching a ligand or oligonucleotide adaptor and subsequently amplifying the nucleic acid molecules.

### FIELD

The present invention relates generally to the field of epigenetic analysis and techniques and methods useful therefor. More particularly, the present invention provides a capture and/or selection method for nucleic acid molecules which have been subject to bisulfite conversion. Epigenetic analysis techniques and kits also form part of the present invention.

### BACKGROUND

Bibliographic details of the publications referred to by author in this specification are collected alphabetically at the end of the description.

Reference to any prior art in this specification is not, and should not be taken as, an acknowledgment or any form of suggestion that this prior art forms part of the common general knowledge in any country.

Cytosine methylation in DNA plays an important role in gene regulation in animal and plant cells. For example, methylation within gene promoters typically leads to transcriptional silencing. In turn, cytosine methylation is involved in the regulation of a variety of cellular processes as well as in development. Increasingly, aberrant cytosine methylation patterns have been implicated in human disease and in particular cancer. Recently, the presence of sequence-specific cytosine methylation in RNA has also been recognized.

Accordingly, there is much interest in the analysis of the extent of cytosine methylation and the locations of methylated cytosine residues.

The methylation of position 5 on the cytosine ring, giving 5-methylcytosine (meC), is one of the most common post-synthetic modifications of DNA and is found in organisms from bacteria to higher eukaryotes including plants and mammals. The context of cytosine methylation varies from the dcm system of bacteria (methylation at CCWGG sites) to widely distributed methylation of cytosines in CpG sites (animal and plant genomes) and CpNpG sites (plant genomes). It also includes asymmetric cytosine methylation that has been observed in certain in plant and fungal systems. Methylation of CpG sites, in particular, within gene regulatory regions and regions of unknown function appears to be characteristic of tissue or cell type, developmental stage or of disease.

Other methylation modifications which are also potentially important include the generation of hydroxymethylcytosines in DNA and as well as methylation of 5-methylcytosine in RNA (among a number of other base modifications in RNA).

Despite the availability of a range of methylation assays (see, for example, Clark et al. Nature Protocols I: 2353-2364, 2006) the scope and cost of large scale (i.e. high content) sequencing is a rate limiting step in developing methylation profiles and associating these with, for example, disease conditions and particular physiological or developmental states.

Bisulfite conversion of DNA has formed the basis of identifying the methylation state of individual genes. With the advent of high throughput parallel sequencing methods, this technology has extended to the sequencing of libraries of bisulfite-treated DNA. The approach can involve fragmenting DNA, ligating linkers, bisulfite treatment and then amplifying the libraries for high throughput sequencing. One of the challenges is mapping of sequences back to unique sites in the genome. Cokus et al, Nature 452:215-9, 2008 use standard linkers modified with 5′ methylcytosine (5meC) to preserve the sequence following bisulfite treatment. In some cases, the relatively small size of a genome, such as, for example, the Arabidopsis genome, facilitates the mapping back to the genome (Lister et al, Cell 133:523-36, 2008). On a larger scale, this approach has recently been applied for the analysis of DNA methylation of cultured human cells (Lister et al, Nature 462: 315-22, 2009).

Random approaches to sequencing of DNA methylation incorporate sequencing of a significant fraction of DNA that contains no 5meC; this is true for mammalian genomes and may be even more so for genomes, such as those of some insects, with a low 5meC content. Methods to limit sequencing to a desired fraction of the genome therefore have significant efficiency and cost benefits. For example, Meissner et al, Nature 454:766-70, 2008 reduced the proportion of the genome analyzed by selecting a defined size class of DNA for amplification after restriction enzyme digestion. This facilitated mapping back to a complex genome. Related approaches include hybridization capture of selected regions of the genome or the capture of the methylated DNA compartment using antibodies to 5meC or the methylated DNA binding proteins.

In order to further facilitate epigenetic analysis and profiling, it would be advantageous to be able to reduce the sample size required for sequencing. This is especially the case for genome-wide epigenetic analysis. This may also assist in mapping selected regions to the genome of a cell.

### SUMMARY

The present invention provides an efficient, cost-effective method for performing epigenetic analysis of nucleic acid molecules. It is particularly useful for enabling high content genome-wide scale epigenetic analysis. The method is predicated in part on reducing the size of a sample to be tested by enriching for regions of a nucleic acid molecule sample to those which are methylated in a cell.

Hence, a modified or improved method for analysis of bisulfite converted nucleic acids is provided. After treatment with sodium bisulfite, unmethylated cytosines are converted to uracil and ultimately to thymine in DNA after copying or amplification. Methylated cytosines remain unaffected and are subsequently amplified as cytosine nucleotides. Consequently, in DNA strands resulting from bisulfite treatment, the only cytosines remaining are those that were previously methylated. By determining the sequence of the DNA and identifying cytosine nucleotides, a profile of methylation in DNA or RNA can be deduced and associated with a physiological state or condition in a cell.

In accordance with one aspect of the present invention, a ligand-dCTP (or conversely a ligand-dGTP depending on which strand is copied) is incorporated into DNA allowing for capture of the methylated fraction on a solid support capable of capturing the ligand. That is the ligand-labelled dCTP or ligand-labelled dGTP is incorporated at the site of a cytosine or complementary guanine, respectively, at positions corresponding to methylated cytosines in the bisulfite-treated nucleic acid. Hence, the ligand-dNTP (where N is cytosine or guanine) binds to a capture molecule immobilized to a solid support. The captured DNA fraction may be amplified or eluted or the strands may be dissociated and therefore either strand may be sequenced or amplified in solution. The sequence of the methylated regions of the sample nucleic acid molecule is therefore determined. This method is described herein as the “capture method”.

In accordance with another aspect of the present invention, the retention of a cytosine nucleotide after bisulfite treatment and copying to form a double-stranded molecule and/or a few rounds of amplification (approximately 2 to 20) is exploited by the use of restriction endonucleases which have a cytosine nucleotide in their target site. Examples include Sau3A [GATC]; Csp6I [GTAC]; Taq1 [TCGA]; and BstU1 [CGCG]. After the copying or amplification step, digestion of the target site in the DNA results in specific ends which provide substrates for the ligation of adaptor primers which in turn can be used for further amplification and/or capture. This aspect conveniently employs adaptors ligated to the cut ends of bisulphite-converted, copied or amplified and digested DNA or corresponding DNA copies of RNA. Other means may be employed to select, analyse or capture restricted DNA. This aspect is referred to as the “restriction method”.

Prior to amplification, the copy DNA will contain the original bisulfite converted strand. This may be selectively degraded such as by uracil deglycosylase, exonuclease digestion of the reverse strand if a phosphorylated primer is used, linear amplification of the forward strand can be used to provide a strongly biased representation, a degradable reverse primer can be used to make the bottom strand unavailable for amplification or by hybridization-based selection used to select the forward strand. After capture, solid or liquid phase amplification may also occur in the case of the capture method or solution PCR and optional capture may be performed in the case of the restriction method.

The capture and restriction methods of the present invention are amenable for high content screening of, for example, genomes or other sources of nucleic acid molecules. It enables the identification of methylation biomarkers for developmental stage or state, tissue type, disease diagnosis, prognosis and pharmacoresponsiveness and pharmacosensitivity in any species, including humans and other mammals, plants, insects and microorganisms (prokaryotes and eukaryotes). The present invention enables time and cost efficient, high throughput epigenetic analysis. The changing profile of genome-wide methylation can also be determined such as during disease progression, treatment, development or cell differentiation.

Hence, the present invention provides a method for selecting or enriching nucleic acid molecules from a source of nucleic acid which may comprise methylated cytosine nucleotides, the method comprising subjecting the original source of nucleic acid to bisulfite conversion and copying the bisulfite converted nucleic acid wherein either (i) the copying is performed in the presence of a ligand-labeled dCTP or dGTP wherein the copied nucleic acid molecules are captured by a capture molecule which binds to the ligand (the “capture” method); or (ii) after the copying, the copied nucleic acid molecules are subject to restriction endonuclease digestion with an enzyme which comprises a cytosine nucleotide in its target recognition sequence to generate nucleic acid fragments with termini proximal or adjacent to one or more cytosines and attaching a ligand or oligonucleotide adaptor and subsequently amplifying the nucleic acid molecules (the “restriction” method).

The latter step may also encompass capturing the nucleic acid molecules prior to or following amplification.

### BRIEF DESCRIPTION OF THE FIGURES

Some figures contain color representations or entities. Color photographs are available from the Patentee upon request or from an appropriate Patent Office. A fee may be imposed if obtained from a Patent Office.

FIG. 1 is a diagrammatic representation of a capture method for methylated RNA or DNA of the present invention.

FIG. 2 is a diagrammatic representation of the use of biotin-dCTP as a capture-ligand-dCTP in a capture method for methylated DNA of the present invention as exemplified herein.

FIGS. 3A and B are graphical representations of (A) NonBiot; and (B) BiotPos amplification. (A) A selection of NonBiot amplification of the heat released and supernatant fractions are indicated. There are background levels of NonBiot amplification of the fraction released from beads. This implies the bead purification is extremely clean. Around 100% of the NonBiot DNA is present in the supernatant fraction. (B) A selection of BiotPos amplification of the heat released and supernatant are indicated. Around ¾ of the BiotPos DNA is held on the beads with around ¼ being present in the supernatant fraction. The capture is stringent and does not retain all starting material. The 2.5 amplification cycle difference corresponds to 21% of the input biotinylated DNA.

FIG. 4 is a photographic representation of eight P1 and P2 ligated genomic libraries prior to cutting from agarose. Molecular weight markers are NEB Low MW marker.

FIG. 5 is a diagrammatic representation of an assay of the present invention using the “restriction method” exemplified herein as applied to DNA for genome-wide scanning. After bisulphite treatment, the sequence of the LUM2-B linker strand (black boxes) is modified so that it is no longer complementary to the LUM2-AMP (clear boxes) strand.

FIG. 6A presents a diagrammatic representation of a semi-nested PCR protocol for identifying the presence of particular gene sequences in the captured, methylated library fractions of Example 3. Panel B shows the results of amplification for the genes GATA5, HOXD1 and ROR2. The correct size PCR products are indicated by dots. For each gene individual tracks are for blood DNA, B; HCT116 DNA, HC; HT29 DNA, HT and SW480 DNA, SW.

FIG. 7 is a diagrammatic representation of methylated DNA/RNA capture using the “cytosine strand” as exemplified herein.

FIG. 8 is a diagrammatic representation of methylated DNA/RNA capture using the “guanine strand” as exemplified herein.

Nucleotide and amino acid sequences are referred to by a sequence identifier number (SEQ ID NO). The SEQ ID NOs correspond numerically to the sequence identifiers <400>1 (SEQ ID NO:1), <400>2 (SEQ ID NO:2), etc.

### DETAILED DESCRIPTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

As used in the subject specification, the singular forms “a”, “an” and “the” include plural aspects unless the context clearly dictates otherwise. Thus, for example, reference to “a nucleic acid molecule” includes a single nucleic acid molecule, as well as two or more nucleic acid molecules; reference to “an amplification” includes a single amplification, as well as multiple rounds of amplification; reference to “the invention” includes a single and multiple aspects of an invention; and so forth.

The present invention facilitates epigenetic analysis and profiling, indicative, instructive or informative of the physiological state or status of a cell or an organism or plant comprising the cell.

In essence, a method for selecting or enriching nucleic acid molecules or a strand complementary thereto is provided wherein the nucleic acid molecules are derived from a nucleic acid which may comprise methylated cytosines. The method is predicated in part on use of the bisulfite conversion procedure which converts unmethylated cytosine nucleotides to uracil (and then to thymine nucleotides during amplification). Other methods, either chemical or enzymatic, that result in selective conversion of cytosine to uracil or thymine may be used. In one embodiment, cytosine nucleotides remaining after the bisulfite treatment can be used to incorporate a ligand attached to a dCTP or to a guanine via a labeled dGTP. The ligand is used to immobilize the DNA via a capture molecule linked to a solid support This is referred to herein as a “ligand-labeled dNTP, wherein N is cytosine or guanine”.

Examples of ligand/capture molecules include biotin/streptavidin and digoxygenin.

In addition or as an alternative, the change in nucleotides following bisulfite treatment can be used to select a restriction endonuclease target site the presence of which is dependent upon the presence of a methylated cytosine prior to the treatment. In this procedure, adaptor primers are ligated to restricted fragments and used to prime complementary strand synthesis. The ends of the restricted fragments are those proximal or adjacent to a previously methylated cytosine.

There are a number of variations to the methods described herein all of which are encompassed by the general concept.

Accordingly, the present invention contemplates a method for capturing a nucleic acid molecule from a sample of nucleic acid which may comprise methylated cytosine nucleotides in a cell or a nucleic acid molecule complementary thereto, the method comprising subjecting a single stranded form of the nucleic acid molecule to bisulfite treatment, subjecting the nucleic acid molecule to a copying or amplification reaction in the presence of a dNTP labeled with a ligand wherein N is cytosine or guanine to incorporate the ligand at the site of a cytosine or complementary guanine in a double-stranded form of the nucleic acid molecule and then capturing the portion of the nucleic acid molecule via immobilization of the ligand to a capture molecule on a solid support.

Another aspect of the present invention provides a bisulfite conversion assay, the assay comprising subjecting a single stranded form of a nucleic acid molecule to bisulfite treatment, subjecting the nucleic acid molecule to a copying or amplification reaction in the presence of a dNTP labeled with a ligand wherein N is cytosine or guanine to incorporate the ligand at the site of a cytosine or complementary guanine in a double-stranded form of the nucleic acid molecule and then capturing the portion of the nucleic acid molecule via immobilization of the capture molecule on a solid support.

Yet another aspect of the present invention is directed to a method for epigenetic profiling of a genome of a cell, the method comprising capturing DNA which was methylated in the genome by subjecting the genome or fragments thereof to bisulfite conversion, incorporating ligand labeled-dCTP or ligand labeled-dGTP into DNA strands by a copy or amplification reaction and capturing the portion or fraction of the genome or its fragments via the ligand and then sequencing and/or identifying the captured strand or its complementary strand.

In these aspects, the captured nucleic acid molecules may be subject to solid phase amplification. Alternatively, via dissociation mechanisms such as melting or other means, a strand may be diluted and used in a templated for solution-phase amplification.

In an alternative embodiment, the bisulfite treated, copied or amplified DNA is subject to restriction endonuclease digestion with an enzyme which requires a cytosine in the enzyme target recognition site. This preferably results in DNA fragments with overhanging 3′ and/or 5′ termini (“sticky ends”). Adaptors are then ligated to the resulting sticky ends which are used to prime amplification reactions. The termini are proximal or adjacent to cytosines which were originally methylated. The amplification step may also be used to incorporate a ligand at the position of a cytosine or guanine for subsequent capture, or a ligand may be incorporated by a fill-in reaction of the sticky-ends. Oligonucleotide adaptors may also be attached.

Consequently; the present invention contemplates a method for enriching a nucleic acid molecule from a source of nucleic acid which may comprise methylated cytosine nucleotides in the original source, the method comprising subjecting a single stranded form of the source of nucleic acid or fragments thereof to bisulfite conversion; copying or amplifying the resulting bisulfite converted nucleic acid molecules; subjecting the resulting amplified nucleic acid molecules to restriction endonuclease digestion using an enzyme which has a cytosine as part of its target recognition sequence; ligating adaptors to the restricted nucleic acid molecules and using these adaptors to prime further amplification or copying.

The present invention further provides a bisulfite conversion assay, the assay comprising subjecting a single stranded form of the source of a nucleic acid or fragments thereof to bisulfite conversion; copying or amplifying the resulting bisulfite converted nucleic acid molecules; subjecting the resulting copied or amplified nucleic acid molecules to restriction endonuclease digestion using an enzyme which has a cytosine as part of its target recognition sequence; ligating adaptors to the restricted nucleic acid molecule and then using the adaptors to prime further copying or amplification.

Still yet another aspect of the present invention relates to a method for enriching genomic DNA which, when in the genome has methylated cytosines, the method comprising subjecting the genome to restriction endonuclease digestion or other disruption means to generate fragments; subjecting single stranded forms of the fragments to bisulfite conversion; copying or amplifying the bisulfite converted DNA and subjecting the copied or amplified DNA to restriction endonuclease digestion with an enzyme which has a cytosine as part of its target recognition sequence; ligating adaptors to the resulting termini and using these to prime further copying or amplification.

These aspects include the optional step of capturing the amplified DNA such as by incorporation of a ligand or a cytosine or guanine.

The present invention also provides a method for selecting or enriching nucleic acid molecules from a source of nucleic acid which may comprise methylated cytosine nucleotides, the method comprising subjecting the original source of nucleic acid to bisulfite conversion and copying the bisulfite converted nucleic acid wherein either (i) the copying is performed in the presence of a ligand-labeled dCTP or dGTP wherein the copied nucleic acid molecules are captured by a capture molecule which binds to the ligand; or (ii) after copying, the copied nucleic acid molecules are subject to restriction endonuclease digestion with an enzyme which comprises a cytosine nucleotide in its target recognition sequence to generate nucleic acid fragments with termini proximal or adjacent to one or more cytosines and attaching a ligand or oligonucleotide adaptor and subsequently amplifying the nucleic acid molecules. The latter step may also encompass capturing the nucleic acid molecules prior to or following amplification.

The adaptors are selected based on downstream capture and sequencing platforms. Hence, the present invention provides a procedure useful for incorporation into a multiplex approach to genome-wide scanning, profiling and detection of methylated DNA or RNA. This information is then used, for example, to identify methylation biomarkers associated with or informative of a particular physiological state or status of a cell, or an organism or plant comprising the cell. The physiological state includes inter alia a disease status, the responsiveness of a subject to a drug, the sensitivity of a subject or a disease in the subject to a drug, the state of differentiation of stem cells, the stage of development of an embryo and the presence of epithelial-mesenchymal transition (EMT) or mesenchymal-epithelial transition (MET) or a stage thereof. Changing methylation profiles in response to treatment can also be determined. In relation to plants, methylation profiles have an impact on the ability for transgenes to be expressed when cells are cultured in vitro. The subject method can be used to monitor these changing profiles. In a particular embodiment, the methylation profile is used to select a particular medicament or agent in the treatment of a disease condition or physiological state.

The nucleic acid molecule subject to this method may be DNA or RNA. If it is RNA, then after bisulfite treatment it is generally subject to reverse transcriptase to generate complementary DNA.

The DNA or RNA may be genomic and may also first be subject to fragmentation using restriction endonucleases or sonication or other disruptive means. Hence, the present invention permits rapid selection or enrichment of fragments or regions of genome or transcriptome which comprised methylated cytosines or their complementary guanines. The ability to analyse methylated portions of a genome or transcriptase rapidly and efficiently, enables lower cost and better targeted sequencing and epigenetic analysis and assists in the identification of methylation biomarkers or epigenetically modified genes.

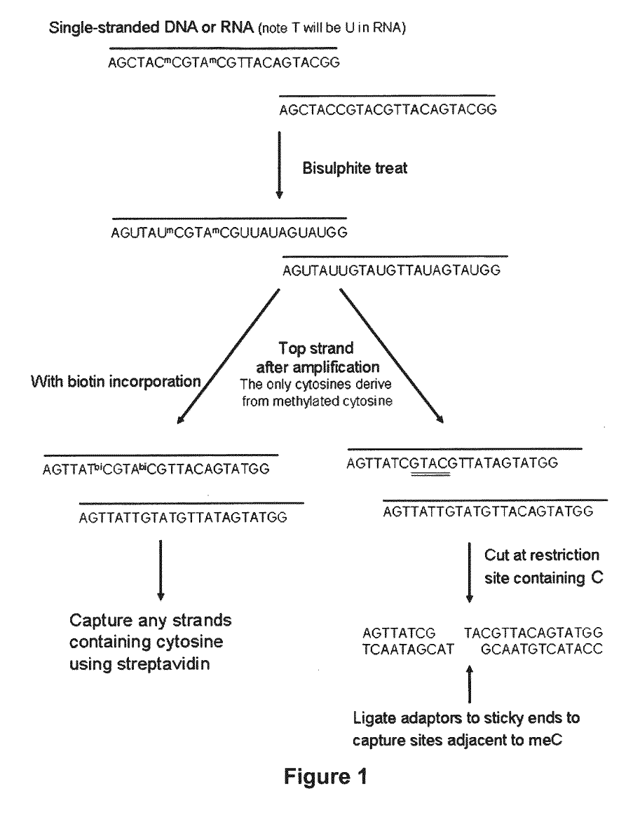

One particular embodiment of the capture and restriction methods of the present invention is shown in FIG. 1. Bisulfite treatment of a DNA strand results in conversion of unmethylated cytosines to uracil. Methylcytosines (^{m}C) remain unchanged. The effects on strands with and without methylcytosines is shown. In one aspect (left hand side), the strand is copied in the presence of biotin-dCTP to incorporate the biotin label (^{bi}C). The incorporation of ^{bi}C means the cytosine was originally methylated. In an unmethylated strand, all cytosines become uracils and thence thymines. The labeled strand (in double-stranded form) is then captured on a solid support comprising streptavidin. Solid phase amplification may then occur or one or both strands dissociated and used in solution phase PCR.

In another aspect, the copying or amplification step (right hand side) is done to generate double-stranded DNA. Generally, amplification is for from about 2 to about 20 cycles. This is then subject to restriction endonuclease digestion using an enzyme having a cytosine in its target recognition sequence (e.g. BstU1 [CGCG]; Taq1 [TCGA]; Sau3A [GATC]; Csp6I [GTAC]). Adaptors are then ligated to the resulting overhanging (“sticky ends”) nucleotide sequences. Cleavage occurs proximal or adjacent to a cytosine that was originally methylated. The adaptors are then used to prime amplification of the cleaved fragments.

The cells may be eukaryotic (e.g. mammalian [e.g. human], insect, yeast, plant) or prokaryotic (e.g. bacteria).

Methylation may occur anywhere within the DNA or RNA including of any cytosine whether located in isolation or contained in CpG islands or other areas of the nucleic acid. Hence, as used herein, the cytosine (C) may be alone or in a CpG site or a CpNpG site.

As used herein, the terms “subject”, “Case”, “patient”, “individual”, “target” and the like refer to any organism or plant or cell of the organism or plant on which an assay of the present invention is performed whether for experimental, diagnostic, prophylactic, and/or therapeutic purposes. Typical subjects include both male and female humans but the present invention extends to any animals whose genome contains 5meC including experimental animals such as non-human primates (e.g., mammals, mice, rats, rabbits, pigs and guinea pigs/hamsters). The “subject” may also be referred to as a population since the present invention is useful in populations studies including epidemiological studies within or between populations of subjects. A “subject” also includes a plant (including tree, shrub, bush, ornamental flowering plant) as well as a microorganism.

The term “genomic DNA” includes all DNA in a cell, group of cells, or in an organelle of a cell and includes exogenous DNA such a transgenes introduced into a cell.

Insofar as the methylation assay involves an amplification reaction, any amplification methodology may be employed. Amplification methodologies contemplated herein include the polymerase chain reaction (PCR) such as disclosed in U.S. Pat. Nos. 4,683,202 and 4,683,195; the ligase chain reaction (LCR) such as disclosed in European Patent Application. No. EP-A-320 308 and gap filling LCR (GLCR) or variations thereof such as disclosed in International Patent Publication No. WO 90/01069, European Patent Application EP-A-439 182, British Patent No. GB 2,225,112A and International Patent Publication No. WO 93/00447. Other amplification techniques include Qβ replicase such as described in the literature; Stand Displacement Amplification (SDA) such as described in European Patent Application Nos. EP-A-497 272 and EP-A-500 224; Self-Sustained Sequence Replication (SSR) such as described in Fahy et al, PCR Methods Appl. 1(1):25-33, 1991) and Nucleic Acid Sequence-Based Amplification (NASBA) such as described in the literature.

A PCR amplification process is particularly useful in the practice of the present invention.

The methods of the present invention are also useful for detecting an increase or decrease in the extent of methylation or changing methylation profiles over time.

Measuring of changing methylation profiles is useful in associating subjects with disease phenotypes and the likelihood of pharmacoresponsiveness or pharmacosensitivity to various treatments. This includes selecting a medicament or therapeutic agent based on methylation profile of an individual or group of individuals. Hence, the method of the present invention is useful in personalized medicine. Changing methylation profiles over the course of a treatment can also be monitored.

A “nucleic acid” as used herein, is a covalently linked sequence of nucleotides in which the 3′ position of the phosphorylated pentose of one nucleotide is joined by a phosphodiester group to the 5′ position of the pentose of the next nucleotide and in which the nucleotide residues are linked in specific sequence; i.e. a linear order of nucleotides. A “polynucleotide” as used herein, is a nucleic acid containing a sequence that is greater than about 100 nucleotides in length. An “oligonucleotide” as used herein, is a short polynucleotide or a portion of a polynucleotide. An oligonucleotide typically contains a sequence of about two to about one hundred bases. The word “oligo” is sometimes used in place of the word “oligonucleotide”. The term “oligo” also includes a particularly useful primer length in the practice of embodiments of the present invention of up to about 30 nucleotides.

As used herein, the term “primer” refers to an oligonucleotide or polynucleotide that is capable of hybridizing to another nucleic acid of interest under particular stringency conditions. A primer may occur naturally as in a purified restriction digest or be produced synthetically, by recombinant means or by PCR amplification. The terms “probe” and “primers” may be used interchangeably, although to the extent that an oligonucleotide is used to initiate nucleic acid synthesis in a PCR or other amplification reaction, the term is generally “primer”. The ability to hybridize is dependent in part on the degree of complementarity between the nucleotide sequence of the primer and complementary sequence on the target DNA. An “adaptor”, is generally an oligonucleotide adaptor. A “ligand” includes a ligand-dCTP or ligand dGTP. Examples of ligands include biotin and digoxygenin.

The terms “complementary” or “complementarity” are used in reference to nucleic acids (i.e. a sequence of nucleotides) related by the well-known base-pairing rules that A pairs with T or U and C pairs with G. For example, the sequence 5′-A-G-T-3′ is complementary to the sequence 3′-T-C-A-5′ in DNA and 3′-U-C-A-5′ in RNA or bisulfite treated genomic DNA. Complementarity can be “partial” in which only some of the nucleotide bases are matched according to the base pairing rules. On the other hand, there may be “complete” or “total” complementarity between the nucleic acid strands when all of the bases are matched according to base-pairing rules. The degree of complementarity between nucleic acid strands has significant effects on the efficiency and strength of hybridization between nucleic acid strands as known well in the art. This is of particular importance in detection methods that depend upon binding between nucleic acids, such as those of the invention. The term “substantially complementary” is used to describe any primer that can hybridize to either or both strands of the target nucleic acid sequence under conditions of low stringency as described below or, preferably, in polymerase reaction buffer heated to 95° C. and then cooled to room temperature. As used herein, when the primer is referred to as partially or totally complementary to the target nucleic acid, that refers to the 3′-terminal region of the primer (i.e. within about 10 nucleotides of the 3′-terminal nucleotide position).

In an embodiment, the capture, enrichment and selection methods of the present invention are an improvement in analyzing the products of a bisulfite conversion assay. Hence, the present invention provides a bisulfite conversion assay, involving subjecting single stranded RNA or DNA to bisulfite conversion to convert unmethylated cytosines to uracils followed by copying (and optionally reverse transcription to generate DNA from RNA), the assay comprising one of (i) performing the copying or amplification in the presence of a capture ligand-labeled dCTP or dGTP; or (ii) after copying or amplification, cleaving the DNA with a restriction endonuclease which requires a cytosine in its target recognition sequence and then ligating adaptor primers or probes to the overhanging sequences. In relation to the latter molecules, these may then be amplified in solution, sequences or have a ligand incorporated therein for subsequent capture.

The present invention also contemplates kits for determining the methylation profile of a nucleic acid including a genome of a eukaryotic or prokaryotic cell. The kits may comprise many different forms but in one embodiment, the kits comprise one or more of reagents for bisulfite conversion, primers, adaptors, ligand-modified dNTPs, solid phase supports and the like.

The kit may also comprise instructions for use.

Conveniently, the kits are adapted to contain compartments for two or more of the above-listed components. Furthermore, buffers, nucleotides and/or enzymes may be combined into a single compartment.

As stated above, instructions optionally present in such kits instruct the user on how to use the components of the kit to perform the various methods of the present invention. It is contemplated that these instructions include a description of the methods of the subject invention.

The present invention further contemplates kits which contain a primer for a nucleic acid target region of interest with the primer. The assay may form an aspect of a multiplex system of bisulfite conversion, capturing, amplification and/or sequencing.

The present invention also contemplates genome-wide screening for epigenetic profiles.

Another important application is in the high content screening of agents which are capable of methylation or demethylation of genomes. This may be important, for example, in modulating the differentiation of cells, cancer therapies and modifying EMT and MET processes.

The present invention further contemplates a computer program and hardware which monitors the changing state, if any, of extent of methylation over time or in response to therapeutic and/or behavioral modification. Such a computer program has important utility in monitoring disease progression, response to intervention, monitoring pharmacoresponsiveness and pharmacosensitivity and may guide modification of therapy or treatment. The computer program is also useful in understanding the association between increasing methylation and disease progression or determining physiological state or status.

Thus, in accordance with the present invention, a computer program monitors levels of methylation in selected loci or proximal thereto or genome-wide which are stored in a machine-readable storage medium, which is capable of processing the data to provide an assessment of physiological status in a subject.

The present invention is further described by the following non-limiting Examples. In these Examples, the following methods are employed.

### EXAMPLES

### General methods

### Cell Lines

Genomic DNA and RNA were extracted from CpG island methylator phenotype (CIMP) cell lines (HCT-116 and HT-29), a non-CIMP cell line (SW-480) as well as human buffy coat DNA (Roche Diagnostics, Australia).

### Shearing of DNA

15 μg of genomic DNA in 300 μL TE buffer (10 mM Tris.HCl, 1 mM EDTA, pH8) in a 1.5 mL microfuge tube was sheared to 90-1000 bp using a Bioruptor (Diagenode, Belgium) for 60 minutes on the High power setting, with alternating 30 sec on and 30 seconds off. The water was changed and ice added every 15 minutes. The DNA was concentrated by ethanol/salt precipitation with resuspension in 50 μL of low EDTA Tris buffer (10 mM Tris-HCl, 0.1 mM EDTA, pH 8.0).

### End Repair

Technical replicates with 2 μg of DNA in each were subject to end repair to ensure flush ends and 5′ phosphorylation for efficient ligation using the End-it kit (Epicentre Biotechnologies). The reaction contained per 2 μg of DNA, 1× End-it buffer, 1 mM ATP, 0.25 mM of each dNTP and 1 μL of End-it enzyme mix (T4 DNA polymerase and polynucleotide kinase). After incubation at room temperature for 45 min the reaction was heated to 70° C. for 10 min to inactivate the T4 DNA polymerase.

### A-Tailing

Repaired DNA was purified and concentrated with a Qiagen MinElute reaction clean up kit. DNA was eluted in 2×16.5 μL of Qiagen Elution Buffer (EB). The eluate was adjusted to 50 μl of NEBuffer 2 (50 mM NaCl, 10 mM Tris-HCl, 10 mM MgCl₂, 1 mM dithiothreitol, pH 7.9 @ 25° C.) containing 200 μM dATP and incubated with 50 units of 3′→5′ exonuclease N-terminal truncated Klenow fragment of DNA polymerase (new England Biolabs). The reaction was stopped by heating at 75° C. for 20 min.

### Linker Annealing

Complementary oligonucleotides were combined in a 0.2 mL PCR tube with Quick ligase buffer (New England Biolabs) to give a final 500 μM concentration. The oligonucleotides were annealed by using a thermal cycler as specified in the Applied Biosystems SOLiD library preparation appendices. Annealed oligonucleotides were keep at −20° C. until required.

### Linker Ligations

DNA ligations were done in Quick Ligase buffer (66 mM Tris-HCl, 10 mM MgCl₂, 1 mM dithiothreitol, 1 mM ATP, 7.5% w/v polyethylene glycol 6000, pH 7.5 @ 25° C.), using 1 μL of Quick ligase per 40 μL of reaction (New. England Biolabs). The ratio of linkers to DNA fragment ends was approximately 10 or 15 to 1. Linkers were removed using a QiaQuick PCR purification kit (Qiagen) and DNA eluted in 40 or 50 μL of EB.

### Restriction Enzyme Digestions

DNAs were cut overnight in restriction enzyme buffers provided by the supplier (Fermentas, buffer B) with 10 U of Csp6I.

### Gel Fractionation

Restriction enzyme reaction products were run on Low-Range agarose (Biorad) gels, stained with SYBR Gold (Invitrogen) and the appropriately sized DNA was cut from the agarose with a scalpel under blue light on a Safe Imager (Invitrogen). For ABI SOLiD-3 and Illumina GA-II sequencing agar containing approximately 125-200 nucleotide and 150-200 nucleotide sized DNA, respectively, was cut from the gel. Cut agar was processed with a Wizard SV Gel extraction and PCR clean up kit (Promega) according to the manufacturer's instructions, excepting that the agarose was dissolved at room temperature.

### Bisulfite Treatment of DNA

Two micrograms of linkered DNA was treated with sodium bisulfite using kits supplied by Human Genetic Signatures.

### Bioinformatics

Sequence data were filtered for quality control using in-house Perl scripts before alignment to Watson and Crick strands of an in silico bisulfite treated complexity reduced Human genome using Genome Workbench 3.5.1 (CLC Genomics) or SHort Read Mapping Package—SHRiMP. (Rumble et al, PloS Comput Biol., 2009). The alignments were linked to annotations using a database and the distribution of reads and statistics calculated using R 2.8.1.

### Oligonucleotodes

The oligonucleotides and gene specific primers used in the Examples described herein are shown in Tables 1 and 2.

TABLE 1
Oliganucleotide sequences

| Description | Sequence (5′-3′) | SEQ ID NO |
|---|---|---|
| SolP2-BP | pGAGAATGAGGAATGTGGGGTAGGTT | 1 |
| SolP2-AB | CCTACCCCACATTCCTCATTCTCT | 2 |
| SolP1-AM * | MMAMTAMGMMTMMGMTTTMMTMTMTATGGGMAGTM | 3 |
| | GGTGAT | |
| SolP1-BC | TAATCACCGACTGCCCATAGAGAGGAAAGCGGAGG | 4 |
| | CGTAGTGGCC | |
| SolP1-A | CCACTACGCCTCCGCTTTCCTCTCTATGGGCAGTC | 5 |
| | GGTGAT | |
| LUM2-AMP * | pGATMGGAAGAGMTMGTATGMMGTMTTMTGMTTGT | 6 |
| | T | |
| LUM2-B | CAAGCAGAAGACGGCATACGAGCTCTTCCGATCT | 7 |
| LUM1-A | CTACACTCTTTCCCTACACGACGCTCTTCCGATCT | 8 |
| LUM1-BS | TAAGATCGGAAGAGCGTCGTGTAGGGAAAGAGTGT | 9 |
| GW_COBRA1b- | CGCAGCCTTAAGTAGAAGATGGTATATGA | 10 |
| Tq | | |
| GW_COBRA1b | CGCAGCCTAAGTAGAAGATGGTATATGA | 11 |
| GW_COBRA2b | CAAGCAGAAGACGGCATACGAG | 12 |
| BiotPosC-A | GCTATACAGGGCGTGTTAACGATATAACGTTTTGG | 13 |
| | CTCGACCAGTGACCGGACTCTCGTTCCTACCAGCG | |
| | CAACGCCCCC | |
| BiotPosC-B | GGGGGCGTTGCGCTGGTAGGAACGAGAGTCCGGTC | 14 |
| | ACTGGTCGAGCCAAAACGTTATATCGTTAACACGC | |
| | CCTGTATAGC | |
| NonBiotC-A | GGCCCGGCGGTCGCCACACCAATTCGTTACTCAGG | 15 |
| | GACGTTACCACGGCTACTATCGTCGCAATTCAGTC | |
| | AGGGATCTCG | |
| NonBiotC-B | CGAGATCCCTGACTGAATTGCGACGATAGTAGCCG | 16 |
| | TGGTAACGTCCCTGAGTAACGAATTGGTGTGGCGA | |
| | CCGCCGGGCC | |

* M is 5-methyl cytosine

TABLE 2
Gene-specific primers

| | | | Location | |
|---|---|---|---|---|
| | | | hg19 | SEQ |
| | | | sequence, | ID |
| Gene | Primers | Sequence (5′ ? 3′) | strand | NO |
| HOXD1 | GWC_HOXD1-Ou | AACRAACTACAAAACCACRAACC | Chr 2: | 17 |
| | | | 177053550, + | |
| | GWC_HOXD1-In | CRACAAAACTTAAATACCAAACTA | | 18 |
| | | AACAC | | |
| GATA5 | GWC_GATA5-Ou | CCRAAACRACAATACCTACCAAAA | Chr 20: | 19 |
| | | C | 61050167, + | |
| | GWC_GATA5-In | RCRCTATTACCTCRAAAACAATTC | | 20 |
| | GWC-GATA5-NegOu | AAAACCRTACAAAACRCTACCATC | Chr 20: | 21 |
| | | | 61050162, − | |
| | GWC-GATA5-NegIn | CCCRACAATCCAAAACTAAACCAC | | 22 |
| GSTP1 | GWC_GSTPI-Ou | AAAAAACCTATTTCCCTATTCCCT | Chr 11: | 23 |
| | | C | 67351913, − | |
| | GWC_GSTPI-In | CCCTACACTCCTAACCCCTCCC | | 24 |
| CNKSR2 | GWC_CNKSR2-Ou | ACCAACAAAAAACCCCACCTAAA | Chr X: | 25 |
| | | | 21393008, − | |
| | GWC_CNKSR2-In | ACCTAAAAACAACTCRAACTACTA | | 26 |
| | | AATTC | | |
| SIX2 | GWC SIX2-Ou | ACCTAAAAACCCAATTTAAACCTC | Chr 2: | 27 |
| | | TC | 45235684, − | |
| | GWC_SIX2-In | CTACRAACCCCTCCCTTAAACC | | 28 |
| ROR2 | GWC_ROR2-Ou | CTTCCCAAATCAAATAATTAAAAA | Chr 9: | 29 |
| | | TATCTA | 94710883, − | |
| | GWC_ROR2-In | ACRTAATCAACATCTACTTAAACT | | 30 |
| | | AAAACC | | |

### Example 1

### Modified Bisulfite Conversion Assay

A method is developed for capturing the fraction of a genome (or nucleic acid sample in general) following bisulfite treatment that contains methylated cytosines. Specifically, it provides a separated fraction corresponding to a methylated portion in a genome or source of nucleic acid that is suitable for high throughput sequencing technologies or targeted analysis of individual genes. The method is summarized in FIG. 1.

After treatment with sodium bisulfite, unmethylated cytosines are converted to uracil (and thence to thymine in amplified DNA) while methylated cytosines remain unreactive and are subsequently amplified as cytosines. Thus, in the DNA strands resulting from bisulfite treatment, the only cytosines remaining are those that were methylated. This invention provides two methods for isolating fractions of DNA based on the presence of cytosine. The first approach relies on the strand-selective incorporation of biotin-dCTP (or conversely biotin-dGTP depending on which strand is copied) allowing the capture of the methylated fraction of DNA using streptavidin coupled to a solid support. An outline of possible schemes is attached at end for both DNA and RNA. The second method utilises the feature that the retention of cytosine (or methylcytosine) in certain sequence contexts results in the presence of a restriction enzyme site that would be absent in the corresponding position if the cytosine had not been methylated. A scheme, of random priming such as for RNA may also be used. For RNA priming, sites may also be introduced by ligation of adaptors to 3′ or 5′ ends of RNAs (e.g. microRNAs). The key feature of the approach is that on the original bisulfite converted strand the only remaining cytosines are those derived from methylated cytosines, hence, capture of biotin labeled molecules from the forward primer strand selects directly for those sequences that were methylated in the original DNA. The other amplified strand contains multiple cytosines (opposite guanines in the bisulfite-treated strand) and, hence, the synthesis steps for the two strands must be done separately or the C-rich strand must be removed to allow selection of methylated molecules. This may be done by degradation of the original bisulfite-converted DNA strand using uracil deglycosylase, by exonuclease digestion of the reverse strand if a phosphorylated primer is used, by linear amplification of the forward stand to provide a strongly biased representation, by using a degradable reverse primer to make the bottom strand unavailable for amplification or by hybridisation-based selection to select the forward strand, for example.

### Example 2

### Capture of Genomic DNA Comprising Methylated Cytosines

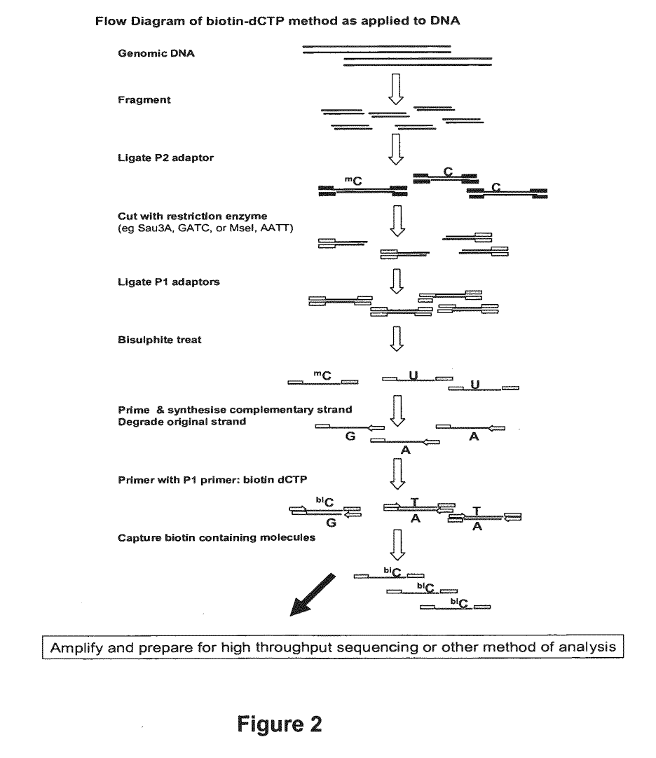

An exemplary diagrammatic representation of this method is shown in FIG. 2. Genomic DNA is fragmented by sonication or enzyme digestion. P2 adaptors that lack cytosine in the top strand are then ligated to the termini of the fragments. The fragments are then subject to restriction endonuclease digestion using an enzyme such as Sau3A or MseI. The resulting ends are ligated to P1 adaptors. The DNA mixture is then subjected to bisulfite treatment which will generate a mixture of single stranded fragments having methylated cytosines or uracils. This mixture is then primed and a complementary strand synthesized. The original strand is now degraded or removed and priming occurs with a P1 primer in the presence of biotin-dCTP. Biotin containing molecules are then captured using streptavidin.

In the following specific example, genomic. DNAs were sonicated to produce DNA fragments ranging in size from 90 to 1000 bp, with most molecules ranging between 100-230 bp. DNA was end-repaired and ligated with annealed linkers SOLP2-AB/SOLP2-BP.

SolP2-BP
(SEQ ID NO: 1)
3′ TTGGATGGGGTGTAAGGAGTAAGAGp
SolP2-AB
(SEQ ID NO: 2)
5′ CCTACCCCACATTCCTCATTCTCT

The linker is adapted from the Applied Biosystems P2 linker used in its SOLiD high throughput sequencing system, the underlined bases in SolP2-BP having replaced cytosines present in the original sequence. The SolP2-BP sequence contains no cytosines so that subsequent incorporation of biotin dCTP will be restricted to the insert sequence.

Subsequent to the first linker ligation, the DNA was cut with the restriction enzyme Csp61 (G′TAC) that leaves a 5′-TA-3′ overhang. These ends were then ligated with the hemimethylated SolP1 linker in which the cytosines on the upper strand SolP1-AM had been replaced with 5-methyl cytosines (shown as “M”) and the a 5′-TA-3′ overhang, underlined, added to the original SolP2-B sequence.

SolP1-AM
(SEQ ID NO: 3)
5′ MMAMTAMGMMTMMGMTTTMMTMTMTATGGGMAGTMGGTGAT
SolP1-BC
(SEQ ID NO: 4)
3′ CGGTGATGCGGAGGCGAAAGGAGAGATACCCGTCAGCCACTAAT

This linker was unphosphorylated, which implies that after ligation to restriction cut DNA the resulting molecule will have a lower stranded nick at the ligation site. The use of 4-base specificity restriction enzymes provides specific starting sites within the genome from which sequences are read. This facilitates alignment of bisulfite-treated DNA to specific genome locations, and is particularly useful for larger (e.g. mammalian) genomes. Following P1 linker ligation, DNA is denatured and treated with sodium bisulfite. In the upper strand, the methyl cytosines in the P1 linker are protected from conversion and the P2 linker strand contains no cytosines, restricting C to U conversion to the insert region. Due to the single stranded nick, after denaturation only the upper strand will have adaptors at both ends. Since adaptors on either end of the single stranded molecules were non-complementary, routine bisulfite conversion conditions could be used. A MethylEasy kit (Human Genetic Signatures) was used as per manufacturer's instructions and treated DNA was resuspended in 30 μL of HGS reagent 3.

Labeling converted material with biotin at sites corresponding to unconverted (methylated) cytosines was performed. The primer SolP2-AB was used to prime and extend on the converted DNA. Following synthesis of the complementary strand, the original bisulfite-treated strand was degraded by treatment with USER enzyme mix that cleaves DNA at positions of uracil bases. The remaining strand was then used as a template for synthesis of the strand corresponding to the original bisulfite treated strand, with incorporation of biotin-dCTP for specific tagging of methylated sites. Briefly, bisulfite-treated DNA (1 μg) was incubated with Invitrogen Platinum Taq DNA polymerase (1 μl, 5 units) in 25 μL Platinum Taq buffer containing 50 μM dNTPs, 2.5 mM MgCl₂ and 500 nmol SolP2-AB primer. After heating at 94° C. for 3 min the reaction was incubated for 15 min at 65° C. The 25 μL of primed strand reaction had 2.5 μL of Arctic phosphatase buffer added along with 5 U of Arctic phosphatase. Incubation was for 30 min at 37° C. with subsequent denaturation of the antartic phosphatase for 8 min at 65° C. The reaction tube was cooled and a mixture of reagents was added to bring the volume to 50 with a final concentration of 100 μM deoxyadenosine-triphosphate, 100 μM deoxyguanosine-triphosphate, 100 μM deoxythymidine-triphosphate and 50 μM biotin-14-deoxycytidine-triphosphate along with 500 nM of SolP1-A primer, 1 U of hot-start Taq, 2 U of uracil-specific excision reagent (USER [Trade Mark]) enzyme mix (New England Biolabs) and 1×Taq buffer. The reaction was incubated for 10 min at 37° C. to, allow uracil DNA glycosylase to degrade uracil containing bisulfite treated DNA before denaturation for 2 min at 94° C. and extension of the template for 10 min at 65° C. A final aliquot containing nmol of unlabeled deoxycytidine-triphosphate was then added, with a further 5 min incubation at 65° C. The product was purified with a QiaQUICK PCR purification kit (Qiagen) and eluted in 200 μL of EB.

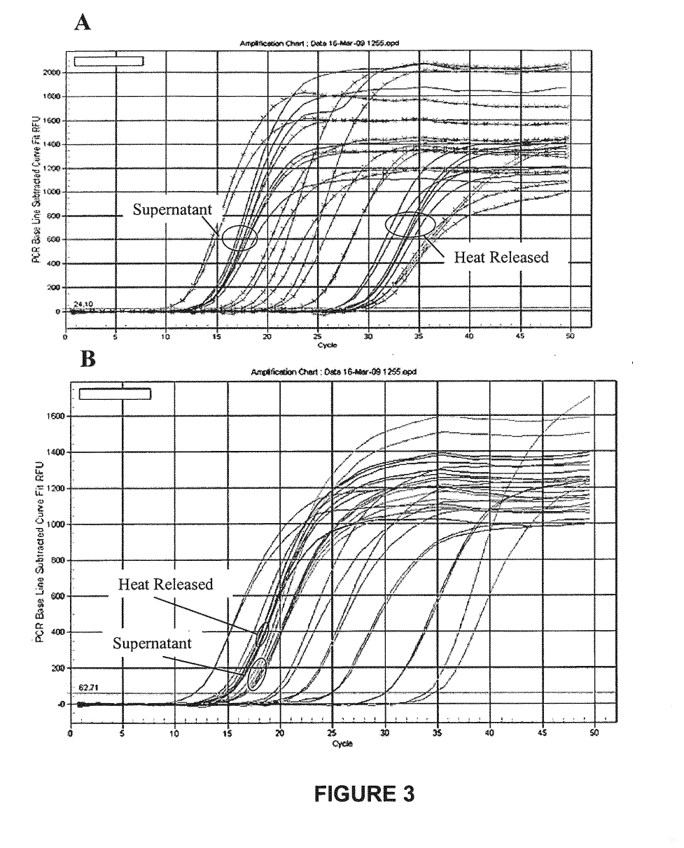

The DNA was then incubated with streptavidin beads in order to bind material labeled with biotin. A series of wash steps selectively enriched for this bound material. Heat denaturation in water allowed the enriched material to be recovered. Bovine serum albumin was used as a blocking agent and a surfactant in the wash steps used to increase the stringency of enrichment. In some instances two different freshly diluted dsDNA oligonucleotide constructs, one with an attached biotin and one without were added to the labeled DNA to allow use of a quantitative PCR assay to measure biotin enrichment. These were designed based upon the MethylMiner kit methylated and non-methylated DNA control duplexes (Invitrogen) with replacement of methylated cytosines by a central biotin labeled thymine nucleotide in towards the centre of the BiotPosC-A oligonucleotide. Briefly, Invitrogen M-270 strepavidin magnetic beads were prepared according to the manufacturer's specifications then washed in 500 μL of 0.1 mg/mL bovine serum albumin before resuspension in 200 μL of 2× binding and wash (B&W) buffer (2 mol/L NaCl, 20 mmol/L Tris-HCl [pH 7.2], 2 mmol/L EDTA and 0.2% v/v Tween80) and the addition of equivolume purified labeled DNA solution. In some instances 10 pg of each control annealed oligonucleotide DNA was also ‘spiked-in’. The 400 μL mixed solution was incubated with gentle rocking for 30 min at 37° C. The tube was placed on a magnet for 3 min before the supernatant was aspirated and kept. Two extra washes were performed—the first with 500 μl 1×B&W buffer and the second with 550 μL water. Then beads were resuspended in 45 μL of water and the tube heated to 90° C. for 2 min and placed immediately on a magnet. The heated water was aspirated as soon as the magnetic beads cleared from solution, 5 μL of 100 mM Tris-HCl pH 8.0, 1 mM EDTA solution was added and the tube. Both the uncaptured and captured and released fractions were aspirated fractions were ethanol precipitated and resuspended in 50 μL of 10 mM Tris-HCl pH 8.0, 0.1 mM EDTA. Quantitative PCR primers and control duplex dilutions were as described in the MethylMiner kit. In separate reactions 2 μL of the uncaptured and captured DNA solutions and additional standard curve control DNA was combined with SYBR GreenER qPCR SuperMix for iCycler and 200 nM primers and cycled on an iCycler thermalcycler (BioRad) for 50 cycles with an initial heat step at 94° C. for 2 minutes, then 50 cycles of 94° C. for 15 sec, 55° C. for 15 sec and 68° C. for 30 sec. Amplifications of each of the captured and supernatant fractions for the non-biotinylated (Panel A) and biotinylated (Panel B) spiked oligonucleotides are shown in FIG. 3. These demonstrate the efficient capture of the biotinylated oligonucleotide and minimal capture of the non-biotinylated oligonucleotide.

Captured DNA was amplified for a limited number of cycles with a hot start Taq polymerase in the presence of 1000 nM of the standard SOLiD P1 and P2 primers. The reverse primer was used to modify the amplicon sequence to match that of the original Applied Biosystems primer 2 sequence. The illegitimate mismatch priming in the first few amplification cycles required a lower annealing temperature. The amplification used 10 sec denaturation steps at 94° C. and 30 second extension steps at 72° C. with annealing steps at 50° C. for the first four cycles before moving to a 62° C. annealing temperature for subsequent cycles. PCR products were purified and quantitated then another few final rounds of PCR were performed with 2 U Phusion Taq (Finnzymes) in 100 μL Phusion Taq High-Fidelity buffer, 1000 nM primers and 10 sec denaturation steps at 98° C., 30 second annealing steps at 62° C. and 30 second extension steps at 72° C. The PCR products were purified using a Qiagen MinElute kit, quantitated with a spectrophotometer (Nanodrop) and sequenced on a Applied Biosystems SOLiD apparatus using SOLiD version 3 chemistry.

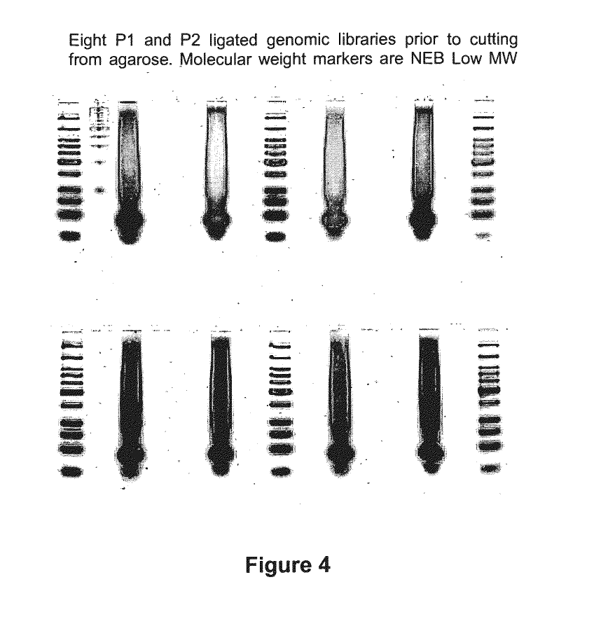

FIG. 4 shows eight P1 and P2 ligated genomic libraries prior to cutting from agarose. Molecular weight markers are NEB Low MW markers. DNA in the size range 125-200 bp was excised from the gel for further analysis and sequencing.

Samples of the libraries were cloned into pGEM-T vector and sequence obtained for 35 independent clones. One clone showed a lack of cytosine conversion and 20% did not contain a CpG site, indicating substantial enrichment but the presence of some background from the biotin capture step.

The four biological samples in two technical replicates were sequenced across one 8-partition slide using Applied Biosystems SOLiD-3 sequencing system. The reads aligned in a Poisson-like negative binomial distribution over the set of locations around Csp6I cut sites (‘sites’). The number of aligned 50 base reads for each library was: blood, 15.2 million; HCT116, 17.6 million; HT29, 29.2 million; SW480, 28.8 million. The profile of reads across the genome from the biotin-streptavidin libraries was very similar to the methylation profile based on complete genome sequence analysis of bisulphite-treated DNA (Lister et al. 2009).

In order to assess the specificity of capture of methylated DNA sequences the inventors examined the frequency of reads of methyl CpGs within 750 bases (−750 to +750) of the transcription start sites (TSS) of genes of known methylation status in the colorectal cancer cell lines HCT116, HT29 and SW480 (see Table 3 below). Reads were inspected and the location of CpGs, relative to the reference genome recorded and the number of CpG sites sequenced at a genome location summed. These summed CpG counts were normalised to yield pseudocounts by using a quantile-to-quantile normalisation method to derive a common library size. The specificity of capture is evident for a number of genes that show differential methylation between the cell lines. For example JPH3 is methylated in both HCT116 and HT29 cells but not in SW480 cells, and BNIP1 is methylated in SW480 and HT29 cells but not in HCT116 cells. A number of the genes in Table 3 have been reported as potential diagnostic markers for colorectal cancer and for many there is a strong differential in their methylation levels in the cancer cell lines in comparison with blood.

TABLE 3
Methylation status of genes

| | Published | | | Normalised sum | | | | |
|---|---|---|---|---|---|---|---|---|
| | methylation | | | of CpG around | | | | |
| | state | | | TSS | | | | |
| Gene symbol | HCT- | HT- | SW- | HCT- | HT- | SW- | | |
| (HGNC) | 116 | 29 | 480 | 116 | 29 | 480 | Blood | Reference |
| ROR2 | U | M | U | 1.2 | 70.7 | 10.7 | 24.0 | Lara, 2010 |
| SIX2 | — | — | — | 107.6 | 76.1 | 74.7 | 1.3 | Zou, 2007 |
| CNKSR2 | M | — | — | 145.5 | 180.9 | 212.1 | 11.9 | Serre, 09 |
| GSTP1 | U | U | U | 14.4 | 8.3 | 0.7 | 14.6 | Paz, 2003 |
| GATA5 | M | M | M | 58.2 | 128.7 | 159.1 | 22.9 | Akiyama, 2003; Serre, 2009 |
| HOXD1 | M | — | — | 306.3 | 85.3 | 84.4 | 13.3 | Serre, 09 |
| ABTB2 | M | — | U | 227.6 | 7.4 | 12.1 | 3.9 | Yagi, 2010 |
| BNIP3 | U | — | M | 0.0 | 114.3 | 101.5 | 0.0 | Yagi, 2010 |
| CDO1 | M | — | M | 53.9 | 58.7 | 94.9 | 0.0 | Yagi, 2010 |
| EDIL3 | M | — | M | 59.2 | 82.1 | 75.4 | 10.0 | Yagi, 2010 |
| FBN2 | M | — | M | 108.2 | 78.8 | 159.8 | 0.0 | Yagi, 2010 |
| ID4 | M | — | M | 79.2 | 114.4 | 36.2 | 0.0 | Yagi, 2010 |
| LOX | M | — | U | 94.2 | 82.3 | 0.7 | 1.7 | Yagi, 2010 |
| PPP1R3C | M | — | U | 120.6 | 112.4 | 68.9 | 0.0 | Yagi, 2010 |
| ZSCAN18 | M | — | M | 148.0 | 221.8 | 232.0 | 8.7 | Yagi, 2010 |
| (ZNF447) | | | | | | | | |
| JPH3 | M | M | U | 280.8 | 132.9 | 1.5 | 6.0 | Jin, 2009; Serre, 2009 |
| IGFBP7 | M | M | U | 80.8 | 90.8 | 0.0 | 0.0 | Lin, 2007; Yagi 2010 |
| DKK3 | M | M | U | 74.1 | 49.4 | 0.0 | 0.0 | Sato, 2007 |
| SFRP2 | M | M | M | 120.4 | 82.9 | 122.4 | 0.0 | Suzuki, 2002 |
| CACNA1G | M | P | U | 157.6 | 20.0 | 0.7 | 0.0 | Weisenberger, 2006 |

M—methylated;
U—unmethylated;
P—partially methylated;
— status unknown.

### Example 3

### Use of Enzyme-Assisted Genome Fragment Capture

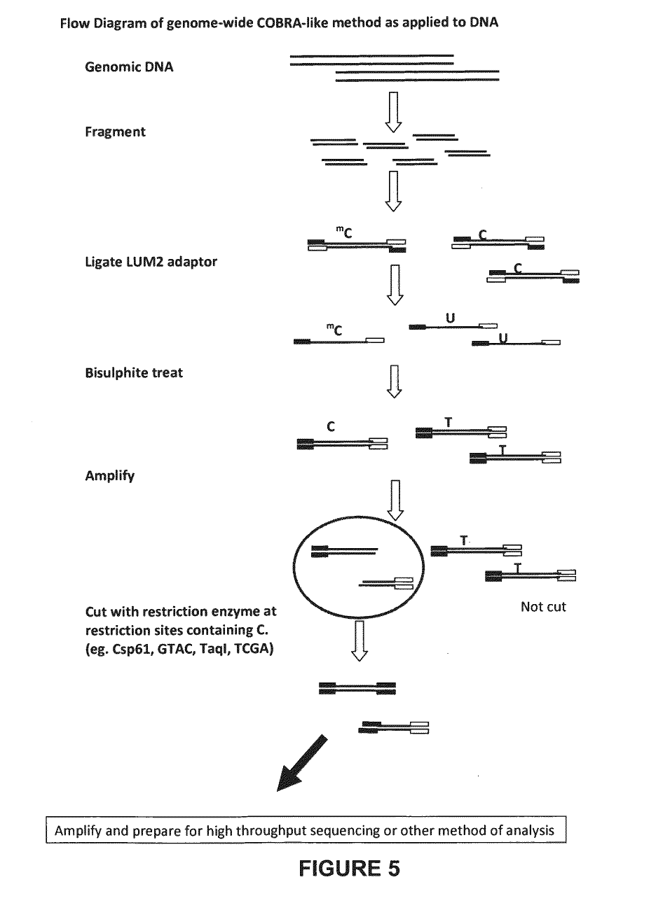

A diagrammatic representation of the “restriction method” disclosed herein for assaying DNA methylation is shown in FIG. 5. This method is amenable to a genome-wise assay of methylation. In general exemplary terms, genomic DNA is fragmented and a P2 adaptor ligated to the termini. These fragments are then bisulfite treated and then subject to amplification. The amplified DNA is then digested with restriction endonucleases at sites containing cytosines (e.g. Sau3A or Taq1) and P1 adaptors then ligated to the termini formed by restriction digestion. The captured (P1-linkered) molecules are then amplified and used for high content sequencing or other analytic procedures.

In the present example, employing the method outlined in FIG. 5, libraries of DNA fragments enriched for methylated sequences were prepared following digestion of bisulfite-treated DNAs with the enzyme Csp61 that cuts at the sequence GTAC. Sheared end-repaired DNAs from 3 colon cancer cell, lines HCT116, HT29 and SW480 and from blood, 2 μg, as in Example 2, were ligated with LUM2 linkers.

LUM2-AMP
(SEQ ID NO: 6)
5′-pGATMGGAAGAGMTMGTATGMMGTMTTMTGMTTGTT
LUM2-B
(SEQ ID NO: 7)
5′-CAAGCAGAAGACGGCATACGAGCTCTTCCGATCT

These are the linkers used with the Illumina GA_{II} high throughput sequencing system. The LUM2-AMP oligonucleotide contains 5-methylcytosines (denoted by “M”) and these will not be converted to uracils in the subsequent bisulfite treatment. Following linker ligation and recovery of linkered DNA, 2 μg DNA was denatured and treated with sodium bisulfite. Since the single stranded molecules have complementary ends introduced by the adaptor they are prone to ‘snapback’ creating hairpin-like DNA structures resistant to bisulfite conversion. A high temperature bisulfite conversion protocol was required to keep most molecules as single strands. As molecules can be rather small after sonication, column-based clean up steps in the bisulfite treatment were avoided. The Xceed kit (Human Genetic Signatures) with a 30 minute step at 80° C. was used for conversion-following by use of MethylEasy kit components and conditions for clean up and precipitation. The treated DNA was resuspended in 30 μL of HGS reagent 3.

The recovered single-stranded DNA can be used as a template for primed strand copying with LUM2-B to generate duplex DNA and may be directly cut with certain restriction enzymes resistant to the presence of uracils. Examples include, TaqI and Csp6I. Alternatively, single stranded DNA with ligated adaptors can be amplified using primers for the methylated conversion-resistant adaptor strand and the unmethylated converted adaptor ligated to the opposite end. In this respect, material containing the same adaptor at each end of a molecule can be efficiently amplified post-bisulfite treatment with selection for bisulfite converted molecules. The amplification method is preferred as ligation of DNA with uracils in sticky ends may be biased. Additionally, amplification of DNA allows the use of methylation sensitive restriction enzymes to cut the DNA later. Taq polymerase or a higher-fidelity polymerase which can read through uracils, such as PfuTurbo Cx (Stratagene) may be used to amplify DNA. In this instance, DNA was amplified in 100 μL reactions with 400 nM primers, 200 μM of each dNTP, 3.5 mM MgCl₂, 1× buffer and 1 U Hot-start. Taq. Amplified DNA was purified using a Qiagen MinElute PCR clean up kit and resuspended in 20 μl of EB. The primer used for the bisulfite converted end was an, “overhanging” primer. This allows an increase in annealing temperature in the later PCR steps. Since Taq polymerase was used for the amplification, the primer, GW-COBRA-Tq, was be designed to accommodate the extra 3′ A nucleotide added during the previous extension round of PCR.

The only cytosines in the upper strand of the insert will correspond with sites of methylated cytosines, and in DNA from mammalian somatic cells these will be in CpG dinucleotides. Depending on the neighbouring sequence, a proportion of cytosines will form restriction sites. This principle has been used previously in a method of analysis of bisulfite-treated DNA termed combined bisulfite and restriction analysis (COBRA). Commonly used sites to detect the presence of DNA methylation are, for example, TaqI, TCGA, and BstUI, CGCG. Here, this principle is combined with linker ligation to allow amplification from a population of molecules those containing methylated cytosine bases in specific sequence contexts. Of course, it is also possible to cut at sites without cytosines, or prior to bisulfite treatment if selection for methylated DNA is not required. To select for molecules with methylated cytosines a restriction site containing a cytosine must be used. There are preferred contexts for the placement and quantity of cytosines with a restriction site and the size and nature of restriction cutting. To select for cytosine methylation in CpG contexts those enzymes with restriction sites containing a singular CpG site are preferred; examples are TaqI and HpyCH2IV. To select for any cytosine methylation use of an enzyme with a restriction site having a singular cytosine at the 3′ end is preferred; examples are Csp6I (and the isoschizomers CviQI and RsaI) and Sau3AI. To select for fewer sites in the genome, 6 or 8 base cutter enzymes may be used; examples are AclI and ClaI. In a particular embodiment, the restriction enzyme cuts to produce a so-called “sticky-end”, overhanging single stranded nucleotides which are more amenable to ligation than so-called “blunt-ends”. Multiple restriction enzymes may also be used to cut the DNA together or separately to increase the density of sites analyzed in the genome.

In this example the duplex DNA was cut with the restriction enzyme Csp61 that has the recognition site GTAC; cutting will mostly occur at sites of original genomic sequence GTACG or GCACG where the underlined C was methylated, and the non-underlined C was converted to uracil by bisulfite treatment. In genomes with a great deal of non-CpG methylation, such as plants or mammalian embryonic stem cells, the Csp6I enzyme may also cut in the subset of GTACH sites, where the underlined C was methylated. In this instance ‘H’ refers to any base but ‘G’.

Cut DNA was ligated to a sequencing adaptor so that sequencing reads commence from restriction cut sites. The LUM1 adaptor has a 5′ TA overhang for efficient ligation to the ends generated by Csp6I digestion.

LUM1-A
(SEQ ID NO: 8)
3′- TCTAGCCTTCTCGCAGCACATCCCTTTCTCACATC
LUM1-BS
(SEQ ID NO: 9)
5′-TAAGATCGGAAGAGCGTCGTGTAGGGAAAGAGTGT

After ligation the DNA library was passed over a Qiagen MinElute column and the DNA resuspended in elution buffer. The eluate was gel fractionated as described in the methods and the purified fractionated DNA then PCR amplified for 10 cycles according to the standard Illumina DNA library preparation protocol. For each cut molecule one half will contain the bisulfite converted adaptor and the other half the unconverted adaptor (FIG. 5). Each half must be amplified discretely using different adaptors. Alternatively, only one half of the molecules are amplified. In this instance molecules containing unconverted LUM2 Illumina sequencing adaptor were amplified.

Libraries were sequenced using Illumina-GA_{IIx} 76 bp chemistry.

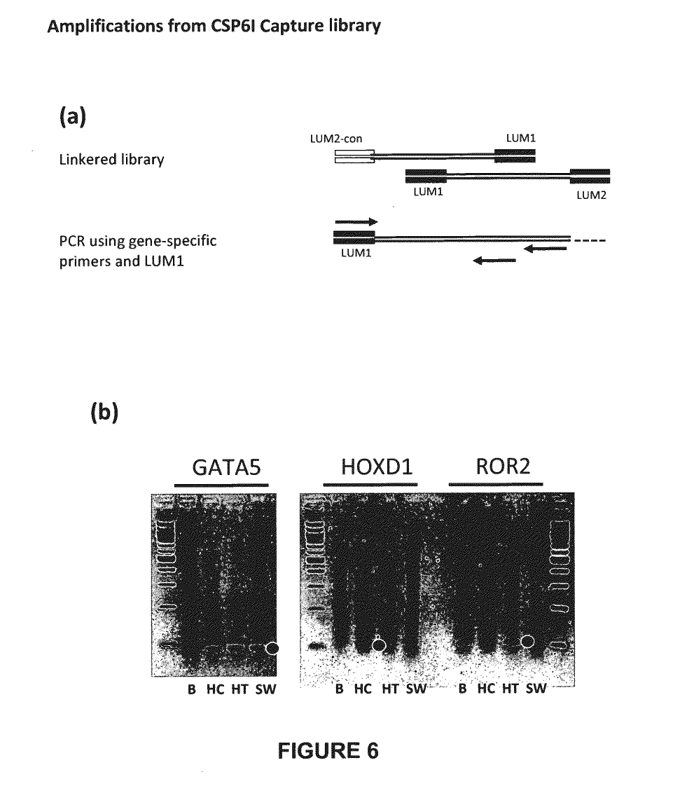

PCR amplifications were done to demonstrate enrichment in the libraries of specific genes of known methylation status. For each gene, a nested pair of primers was used in two rounds of PCR in combination with the linker primer LUM1-A. (FIG. 6A). The sequences of the primers are shown in Table 2 above. PCRs were done in 20 uL reactions containinig Platinum Taq buffer containing 200 uM dNTP's, 400 nM forward and reverse primers, 3.5 mM MgCl₂ and 1 unit of Platinium Taq DNA polymerase. Cycling conditions for the first round were 95° C. 2 m; 95° C. 20 s, 51° C. 20 s, 72° C. 30 s for 2 cycles; then 95° C. 20 s, 57° C. 20 s, 72° C. 30 s for 10 cycles. 0.4 uL was taken for second round amplification. Cycling conditions were 95° C. 2 min; 95° C. 20 s, 57° C. 30 s, 72° C. 30 s for 2 cycles; then 95° 20 s, 60° C. 30 s, 72° C. 30 s for 36 cycles.

Results of nested PCRs for three genes, GATA5, HOXD1 and ROR2 are shown in FIG. 6B. The presence of specific amplification products for blood DNA and the three colorectal cancer cell lines is consistent with published data and with methylation sequencing data at the specific Csp6I sites obtained in Example 2 (Table 3). Specifically, GATA5 is methylated in all three colon cancer lines; HOXD1 is most strongly methylated HCT116; ROR2 is most strongly methylated in DNA from blood and HT29. These data demonstrate that the selectivity of capture of methylated sequences in the libraries is both gene and cell-type specific.

### Example 4

### Methylated DNA/RNA Capture (“Cytosine Strand”)

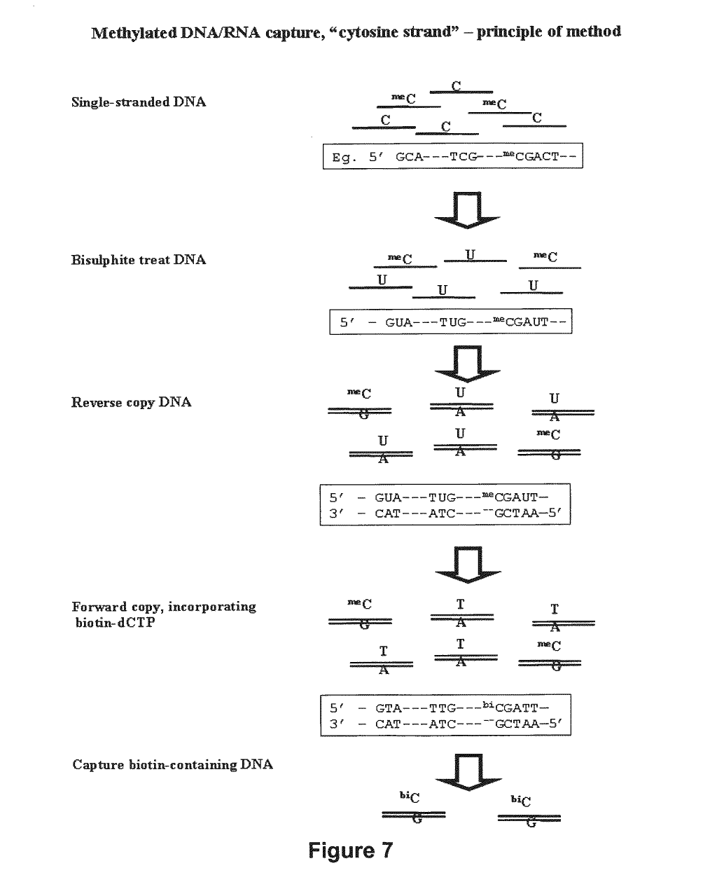

An exemplary diagrammatic representation of this method is shown in FIG. 7. This describes the general approach of which the linker/amplification method of Example 2 represents a specific example.

Single stranded DNA or RNA containing methylated and unmethylated cytosine nucleotides is bisulfite treated to generate fragments comprising methylated cytosine or uracil residues. This is then reverse copied to generate double-stranded DNA or DNA/RNA hybrid which is then forward copied in the presence of biotin-dCTP. Biotin labeled DNA is then captured, either as the synthesised duplex or as single-stranded DNA after denaturation. Subsequent analysis may be done of the biotin-labeled DNA strand or of its captured complement.

### Example 5

### Methylated DNA/RNA Capture (“Guanine Strand”)

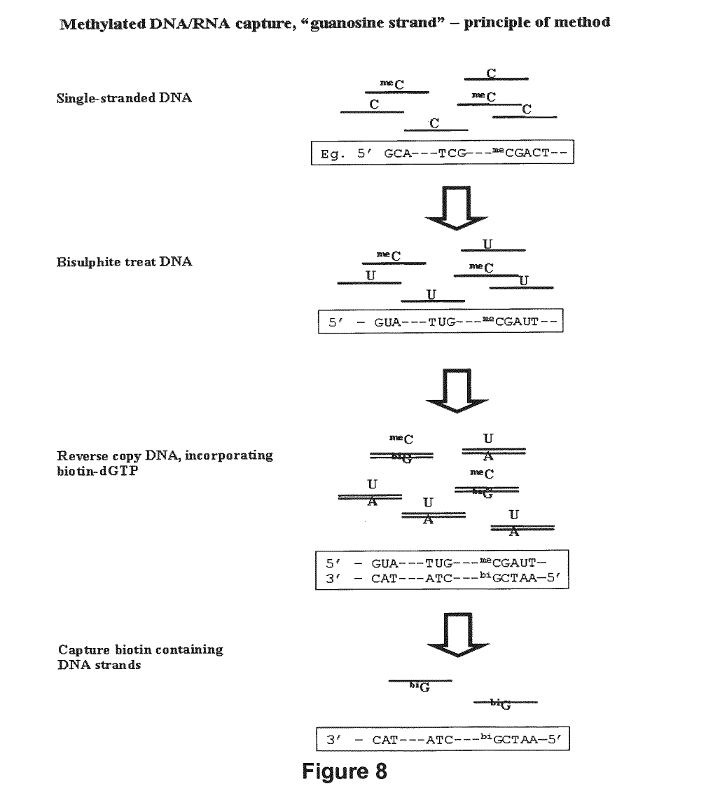

An exemplary diagrammatic representation of this method is shown in FIG. 8.

Single stranded DNA or RNA containing methylated and unmethylated cytosine nucleotides is bisulfite treated to generate fragments comprising methylated cytosine or uracil residues. This is reverse copied in the presence of biotin-dGTP. Biotin labeled nucleic acid is then captured, either as duplex DNA or DNA/RNA hybrid or as single-stranded DNA after denaturation. Subsequent analysis may be done of the biotin-labeled DNA strand or of its captured DNA or RNA complement.

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations of any two or more of said steps or features.

### REFERENCES

Akiyama et al, Molecular and Cellular Biology, 23: 8429-8439, 2003.
Cokus et al, Nature 452:215-9, 2008
Clark et al. 2006, Nature Protocols I: 2353-2364
Jin et al, Cancer Research, 69: 7412-21, 2009.
Lara et al, Molecular Cancer, 9: 170, 2010
Lin et al, Journal of Pathology, 12: 83-90, 2007.
Lister et al, Cell 133:523-36, 2008
Lister et al, Nature Epub (19829295), Oct. 14, 2009
Meissner et al, Nature 454:766-70, 2008
Paz et al, Cancer Research, 63: 1114-1121, 2003.
Rein et al, Nucleic Acids Res. 26:2255, 1998
Rumble et al, PloS Comput Biol., 2009
Sato et al, Carcinogenesis, 28: 2459-2466, 2007.
Serre et al, Nucleic Acids Research, 38: 391-9, 2010.
Smith et al, In press Methods 49, 2009
Suzuki et al., Nat Genet, 31: 141-149, 2002.
Weisenberger et al, Nat Genet, 38: 787-793, 2006
Yagi et al, Clinical Cancer Res, 16: 21-33, 2010
Zou et al, Cancer Epidemiology, Biomarkers & Prevention, 16: 2686-2696, 2007.

1. A method for capturing selecting or enriching nucleic acid molecules from a source of nucleic acid which may comprise methylated cytosine nucleotides, the method comprising subjecting the original source of nucleic acid to bisulfite conversion and copying and/or amplifying the bisulfite converted nucleic acid wherein either (i) the copying or amplification is performed in the presence of a ligand-labelled dCTP or a ligand-labelled dGTP wherein the ligand-labelled dCTP or ligand-labelled dGTP is incorporated at the site of a cytosine or complementary guanine, respectively, at positions corresponding to methylated cytosines in the bisulfite-treated nucleic acid and wherein the copied or amplified nucleic acid molecules are captured by a capture molecule which binds to the ligand; or (ii) after the copying or amplification, the resulting nucleic acid molecules are subject to restriction endonuclease digestion with an enzyme which comprises a cytosine nucleotide in its target recognition sequence to generate nucleic acid fragments with termini proximal or adjacent to one or more cytosines and attaching a ligand or oligonucleotide adaptor and subsequently amplifying the nucleic acid molecules.

2. The method of claim 1 wherein the nucleic acid molecules are DNA.

3. The method of claim 1 wherein the nucleic acid molecules are RNA which after bisulfite treatment are subject to reverse transcriptase treatment to generate DNA.

4. The method of claim 2 wherein the nucleic acid molecules represent a genome or transcripts thereof from a cell.

5. The method of claim 4 wherein the cell is a eukaryotic cell.

6. The method of claim 5 wherein the eukaryotic cell is selected from a mammalian, insect, yeast and plant cell.

7. The method of claim 4 wherein the cell is a prokaryotic cell.

8. The method of claim 1 wherein the ligand is biotin and capture molecule is streptavidin.

9. The method of claim 1 wherein the captured nucleic acid molecules are amplified then eluted and/or a strand sequenced.

10. The method of claim 1 wherein the strands of the captured nucleic acid molecules are dissociated from each other and the strands complementary to the captured strands are sequenced.

11. The method of claim 1 wherein the nucleic acid molecules are cleaved with one or more restriction endonucleases to generate fragments which are then ligated to an adaptor.

12. The method of claim 11 wherein the adaptor-ligated fragments are subject to amplification using the adaptor as a primer.

13. A method for capturing a nucleic acid molecule from a sample of nucleic acid which may comprise methylated cytosine nucleotides in a cell or a nucleic acid molecule complementary thereto, said method comprising subjecting a single stranded form of the nucleic acid molecule to bisulfite treatment, subjecting the nucleic acid molecule to a copying or amplification reaction in the presence of a dNTP labeled with a ligand wherein N is cytosine or guanine to incorporate the ligand at the site of a cytosine or complementary guanine in a double-stranded form of the nucleic acid molecule and corresponding to a methylated cytosine in the nucleic acid molecule from the sample of nucleic acid and then capturing the portion of the nucleic acid molecule via immobilization of the ligand to a capture molecule on a solid support.

14. A bisulfite conversion assay, said assay comprising subjecting a single stranded form of a nucleic acid molecule to bisulfite treatment, subjecting the nucleic acid molecule to a copying or amplification reaction in the presence of a dNTP labeled with a ligand wherein N is cytosine or guanine to incorporate the ligand at the site of a cytosine or complementary guanine in a double-stranded form of the nucleic acid molecule and corresponding to a methylated cytosine in the single stranded form of the nucleic acid molecule and then capturing the portion of the nucleic acid molecule via immobilization of the capture molecule on a solid support.

15. The method of claim 13, wherein the method is for epigenetic profiling of a genome of a cell.

16.-18. (canceled)


SEQUENCE LISTING (30 sequences)

SEQ ID NO: 1 - DNA, 25 bp, Artificial Sequence
  Synthetic Oligonucleotide
gagaatgaggaatgtggggtaggtt

SEQ ID NO: 2 - DNA, 24 bp, Artificial Sequence
  Synthetic Oligonucleotide
cctaccccacattcctcattctct

SEQ ID NO: 3 - DNA, 41 bp, Artificial Sequence
  Synthetic Oligonucleotide
ccactacgcctccgctttcctctctatgggcagtcggtgat

SEQ ID NO: 4 - DNA, 45 bp, Artificial Sequence
  Synthetic Oligonucleotide
taatcaccgactgcccatagagaggaaagcggaggcgtagtggcc

SEQ ID NO: 5 - DNA, 41 bp, Artificial Sequence; identical to SEQ ID NO: 3
  Synthetic Oligonucleotide

SEQ ID NO: 6 - DNA, 35 bp, Artificial Sequence
  Synthetic Oligonucleotide
gatcggaagagctcgtatgccgtcttctgcttgtt

SEQ ID NO: 7 - DNA, 34 bp, Artificial Sequence
  Synthetic Oligonucleotide
caagcagaagacggcatacgagctcttccgatct

SEQ ID NO: 8 - DNA, 35 bp, Artificial Sequence
  Synthetic Oligonucleotide
ctacactctttccctacacgacgctcttccgatct

SEQ ID NO: 9 - DNA, 35 bp, Artificial Sequence
  Synthetic Oligonucleotide
taagatcggaagagcgtcgtgtagggaaagagtgt

SEQ ID NO: 10 - DNA, 29 bp, Artificial Sequence
  Synthetic Oligonucleotide
cgcagccttaagtagaagatggtatatga

SEQ ID NO: 11 - DNA, 28 bp, Artificial Sequence
  Synthetic Oligonucleotide
cgcagcctaagtagaagatggtatatga

SEQ ID NO: 12 - DNA, 22 bp, Artificial Sequence
  Synthetic Oligonucleotide
caagcagaagacggcatacgag

SEQ ID NO: 13 - DNA, 80 bp, Artificial Sequence
  Synthetic Oligonucleotide
gctatacagggcgtgttaacgatataacgttttggctcgaccagtgaccggactctcgttcctaccagcgcaacgccccc

SEQ ID NO: 14 - DNA, 80 bp, Artificial Sequence
  Synthetic Oligonucleotide
gggggcgttgcgctggtaggaacgagagtccggtcactggtcgagccaaaacgttatatcgttaacacgccctgtatagc

SEQ ID NO: 15 - DNA, 80 bp, Artificial Sequence
  Synthetic Oligonucleotide
ggcccggcggtcgccacaccaattcgttactcagggacgttaccacggctactatcgtcgcaattcagtcagggatctcg

SEQ ID NO: 16 - DNA, 80 bp, Artificial
  Synthetic
cgagatccctgactgaattgcgacgatagtagccgtggtaacgtccctgagtaacgaattggtgtggcgaccgccgggcc

SEQ ID NO: 17 - DNA, 23 bp, Artificial Sequence
  Synthetic Oligonucleotide
aacraactacaaaaccacraacc

SEQ ID NO: 18 - DNA, 29 bp, Artificial Sequence
  Synthetic Oligonucleotide
cracaaaacttaaataccaaactaaacac

SEQ ID NO: 19 - DNA, 25 bp, Artificial Sequence
  Synthetic Oligonucleotide
ccraaacracaatacctaccaaaac

SEQ ID NO: 20 - DNA, 24 bp, Artificial Sequence
  Synthetic Oligonucleotide
rcrctattacctcraaaacaattc

SEQ ID NO: 21 - DNA, 24 bp, Artificial Sequence
  Synthetic Oligonucleotide
aaaaccrtacaaaacrctaccatc

SEQ ID NO: 22 - DNA, 24 bp, Artificial Sequence
  Synthetic Oligonucleotide
cccracaatccaaaactaaaccac

SEQ ID NO: 23 - DNA, 26 bp, Artificial Sequence
  Synthetic Oligonucleotide
aaaaaaccttatttccctattccctc

SEQ ID NO: 24 - DNA, 22 bp, Artificial Sequence
  Synthetic Oligonucleotide
ccctacactcctaacccctccc

SEQ ID NO: 25 - DNA, 23 bp, Artificial Sequence
  Synthetic Oligonucleotide
accaacaaaaaaccccacctaaa

SEQ ID NO: 26 - DNA, 29 bp, Artificial Sequence
  Synthetic Oligonucleotide
acctaaaaacaactcraactactaaattc

SEQ ID NO: 27 - DNA, 26 bp, Artificial Sequence
  Synthetic Oligonucleotide
acctaaaaacccaatttaaacctctc

SEQ ID NO: 28 - DNA, 22 bp, Artificial Sequence
  Synthetic Oligonucleotide
ctacraacccctcccttaaacc

SEQ ID NO: 29 - DNA, 30 bp, Artificial Sequence
  Synthetic Oligonucleotide
cttcccaaatcaaataattaaaaatatcta

SEQ ID NO: 30 - DNA, 30 bp, Artificial Sequence
  Synthetic Oligonucleotide
acrtaatcaacatctacttaaactaaaacc